(19) United States
(12) Patent Application Publication
(10) Pub. No.: US 2023/0177698 A1
(43) Pub. Date: Jun. 8, 2023

(54) METHOD FOR IMAGE SEGMENTATION, AND ELECTRONIC DEVICE

(71) Applicant: Infervision Medical Technology Co., Ltd., Beijing (CN)

(72) Inventors: Weidao CHEN, Beijing (CN); Shaokang WANG, Beijing (CN); Kuan CHEN, Beijing (CN)

(73) Assignee: Infervision Medical Technology Co., Ltd., Beijing (CN)

(21) Appl. No.: 18/161,735

(22) Filed: Jan. 30, 2023

Related U.S. Application Data
(63) Continuation of application No. PCT/CN2021/113068, filed on Aug. 17, 2021.

(30) Foreign Application Priority Data
Sep. 22, 2020 (CN) 202011002964.1

(51) Int. Cl. G06T 7/11; G06T 7/00; G06T 7/136; G06T 7/187; G06T 7/155

(52) U.S. Cl. CPC G06T 7/11; G06T 7/0012; G06T 7/136; G06T 7/187; G06T 7/155; G06T 2207/30016; G06T 2207/20192; G06T 2207/20036; G06T 2207/20084

(57) ABSTRACT

Disclosed are a method for image segmentation, and an electronic device. The method includes: performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image; and acquiring a final segmentation result of the cerebral hematoma in the head medical image based on the secondary segmentation result, so that a segmentation effect of a cerebral hematoma in a head medical image can be improved in a case that the head medical image has data heterogeneity.

### CROSS-REFERENCE TO RELATED APPLICATIONS

This application is a continuation application of International Application No. PCT/CN2021/113068, filed on Aug. 17, 2021, which claims priority to Chinese Patent Application No. 202011002964.1, filed on Sep. 22, 2020. Both applications are incorporated herein by reference in their entireties.

### TECHNICAL FIELD

The present application relates to the field of image processing technologies, and in particularly, to a method and an apparatus for image segmentation, and an electronic device.

### BACKGROUND

Intracerebral hemorrhage refers to brain internal bleeding caused by rupture of blood vessels. Medically, the intracerebral hemorrhage is mainly spontaneous non-traumatic intracerebral hemorrhage, that is, spontaneous intracerebral hemorrhage. The spontaneous intracerebral hemorrhage is usually caused by factors such as hypertension, hyperglycemia, hyperlipidemia, and smoking. The onset of the disease is sudden and dangerous, with high treatment costs, a recurrence rate, a disability rate and a mortality rate. More than 40% of patients with the intracerebral hemorrhage will die within one month, and 80% of surviving patients need to rely on the care of others to live.

### SUMMARY

In view of the above, embodiments of the present application provide a method and an apparatus for image segmentation, and an electronic device, so that a segmentation effect of a cerebral hematoma in a head medical image can be improved in a case that the head medical image has data heterogeneity.

According to a first aspect of an embodiment of the present application, a method for image segmentation is provided, including: performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image; and acquiring a final segmentation result of the cerebral hematoma in the head medical image based on the secondary segmentation result.

In one embodiment, the performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image includes: performing binarization processing on the preliminary segmentation result, to obtain a binary image corresponding to the preliminary segmentation result; performing extraction of a connected region of the cerebral hematoma in the binary image, to obtain at least one first connected region of the head medical image; and performing the secondary segmentation of the cerebral hematoma on the pre-processed head medical image by using the at least one first connected region of the head medical image as a reference, to obtain the secondary segmentation result.

In one embodiment, the performing the secondary segmentation of the cerebral hematoma on the pre-processed head medical image by using the at least one first connected region of the head medical image as a reference, to obtain the secondary segmentation result includes: acquiring a seed point, corresponding to a center point of each of the at least one first connected region, of the pre-processed head medical image; obtaining at least one second connected region of the pre-processed head medical image by using a region growth algorithm and based on a preset boundary threshold and the seed point; and acquiring the secondary segmentation result based on the at least one second connected region of the pre-processed head medical image.

In one embodiment, the acquiring the secondary segmentation result based on the at least one second connected region of the pre-processed head medical image includes: performing morphological processing on each of the at least one second connected region, to obtain a plurality of second sub-connected regions corresponding to the second connected region; obtaining at least one third connected region of the pre-processed head medical image by using a preset rule and based on the plurality of second sub-connected regions; and determining the at least one third connected region as the secondary segmentation result.

In one embodiment, the acquiring a final segmentation result of the cerebral hematoma in the head medical image based on the secondary segmentation result includes: acquiring the final segmentation result based on the at least one third connected region.

In one embodiment, in a case that the at least one second connected region comprises at least two second connected regions, the obtaining at least one third connected region of the pre-processed head medical image by using a preset rule and based on the plurality of second sub-connected regions includes: determining, based on a quantity of the plurality of second sub-connected regions, whether to remove a second connected region corresponding to the plurality of second sub-connected regions, to obtain at least one fourth connected region of the pre-processed head medical image, each of the at least one fourth connected region corresponding to a plurality of fourth sub-connected regions; and determining, based on an area of each of the plurality of fourth sub-connected regions, whether to remove the fourth sub-connected region, to obtain the at least one third connected region.

In one embodiment, the determining, based on a quantity of the plurality of second sub-connected regions, whether to remove a second connected region corresponding to the plurality of second sub-connected regions, to obtain at least one fourth connected region of the pre-processed head medical image includes: comparing the quantity of the plurality of second sub-connected regions with a preset quantity threshold; and removing the second connected region having a quantity of the plurality of second sub-connected regions greater than the preset quantity threshold, to obtain the at least one fourth connected region.

In one embodiment, the determining, based on an area of each fourth sub-connected region of the plurality of fourth sub-connected regions, whether to remove the fourth sub-connected region, to obtain the at least one third connected region includes: comparing an area of each of the plurality of fourth sub-connected regions with a cerebral hematoma area threshold; and removing the fourth sub-connected region, having an area less than the cerebral hematoma area threshold, of the plurality of fourth sub-connected regions, to obtain the at least one third connected region.

In one embodiment, the obtaining at least one third connected region of the pre-processed head medical image by using a preset rule and based on the plurality of second sub-connected regions includes: determining, based on an area of each of the plurality of second sub-connected regions, whether to remove the second sub-connected region, to obtain the at least one third connected region.

In one embodiment, in a case that the at least one second connected region comprises at least two second connected regions, the obtaining at least one third connected region of the pre-processed head medical image by using a preset rule and based on the plurality of second sub-connected regions includes: determining, based on a quantity of the plurality of second sub-connected regions, whether to remove a second connected region corresponding to the plurality of second sub-connected regions, to obtain the at least one third connected region.

In one embodiment, in a case that the at least one third connected region comprises at least two third connected regions, the acquiring the final segmentation result based on the at least one third connected region includes: performing a matrix addition operation on the at least two third connected regions, to obtain a matrix addition operation value corresponding to each pixel of the pre-processed head medical image, the matrix addition operation value being obtained by adding at least two binary values; performing, based on a matrix addition operation threshold, majority vote binarization processing on the matrix addition operation value corresponding to each pixel of the pre-processed head medical image, to obtain a final connected region of the cerebral hematoma in the pre-processed head medical image; and performing a matrix addition operation on the final connected region and the at least one first connected region, to obtain the final segmentation result.

In one embodiment, in a case that the at least one third connected region comprises one third connected region, the acquiring the final segmentation result based on the at least one third connected region includes: performing a matrix addition operation on the one third connected region and the at least one first connected region, to obtain the final segmentation result.

In one embodiment, the method further includes obtaining the preliminary segmentation result by using a network model and based on the head medical image.

In one embodiment, the method further includes performing curvature filtering on the head medical image to obtain the pre-processed head medical image.

According to a second aspect of an embodiment of the present application, an apparatus for image segmentation is provided, including a secondary segmentation module, configured to: perform, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image; and an acquisition module, configured to acquire a final segmentation result of the cerebral hematoma in the head medical image based on the secondary segmentation result.

In one embodiment, the apparatus further includes modules for implementing the steps in the method for image segmentation mentioned in the above embodiments.

According to a third aspect of an embodiment of the present application, an electronic device is provided, including a processor; and a memory for storing processor-executable instructions, and the processor is configured to implement the method for image segmentation described in any one of the above embodiments.

According to a fourth aspect of an embodiment of the present application, a computer-readable storage medium is provided, and the computer-readable storage medium stores a computer program for implementing the method for image segmentation described in any one of the above embodiments.

According to the method for image segmentation provided in the embodiments of the present application, the secondary segmentation of the cerebral hematoma is performed on the pre-processed medical head image on the basis of the preliminary segmentation result of the cerebral hematoma in the medical head image to obtain the secondary segmentation result of the cerebral hematoma in the pre-processed medical head image, and the final segmentation result of the cerebral hematoma in the medical head image is obtained based on the secondary segmentation result, so that the segmentation effect of the cerebral hematoma in the head medical image can be improved in a case that the head medical image has data heterogeneity.

### BRIEF DESCRIPTION OF THE DRAWINGS

The above and other objects, features and advantages of the present application will become more apparent from a more detailed description of embodiments of the present application with reference to the accompanying drawings. The accompanying drawings are included to provide a further understanding of the embodiments of the present application and constitute a part of the specification, serve to explain the present application together with the embodiments of the present application, and are not to be construed as limiting the present application. In the accompanying drawings, like reference numerals generally refer to like parts or steps.

FIG. 1 is a schematic diagram of an implementation environment according to an embodiment of the present application.

FIG. 2 is a block diagram of a system for image segmentation according to an embodiment of the present application.

FIG. 3 is a schematic flowchart of a method for image segmentation according to an embodiment of the present application.

FIG. 4a is a schematic diagram of a preliminary segmentation result of a cerebral hematoma according to an embodiment of the present application.

FIG. 4b is a schematic diagram of a final segmentation result of a cerebral hematoma according to an embodiment of the present application.

FIG. 5 is a schematic flowchart of a method for image segmentation according to another embodiment of the present application.

FIG. 6 is a schematic flowchart of a method for image segmentation according to another embodiment of the present application.

FIG. 7 is a schematic flowchart of a method for image segmentation according to another embodiment of the present application.

FIG. 8 is a schematic flowchart of a method for image segmentation according to another embodiment of the present application.

FIG. 9 is a block diagram of an apparatus for image segmentation according to an embodiment of the present application.

FIG. 10 is a block diagram of an apparatus for image segmentation according to another embodiment of the present application.

FIG. 11 is a block diagram of an apparatus for image segmentation according to still another embodiment of the present application.

FIG. 12 is a block structural diagram of an electronic device according to an embodiment of the present application.

### DETAILED DESCRIPTION OF THE EMBODIMENTS

The technical solutions in the embodiments of the present application will be clearly and completely described below in combination with the accompanying drawings in the embodiments of the present application. It will be apparent that the described embodiments are only a part of the embodiments of the present application, rather than all the embodiments. All other embodiments obtained by a person of ordinary skill in the art based on the embodiments of the present application without involving any creative efforts fall within the protection scope of the present application.

Overview

A medical image is an image that reflects an internal structure or internal function of an anatomical region and is composed of a set of image elements: a pixel (2D) or a stereoscopic pixel (3D). The medical image is characterized by a discrete image produced by sampling or reconstruction, which can map values to different spatial positions. Most of the medical images are radiation imaging, functional imaging, magnetic resonance imaging, and ultrasound imaging. The medical images are mostly single-channel gray-scale images. Although a large number of medical images are 3D images, there is no concept of depth of field in the medical images.

A deep learning implements artificial intelligence in a computing system by establishing an artificial neural network with a hierarchical structure. Since the artificial neural network with a hierarchical structure can extract and filter input information layer by layer, the deep learning has a capability of representing learning, and may realize an end-to-end supervised learning and unsupervised learning. The artificial neural network with the hierarchical structure used for the deep learning has a variety of forms, and hierarchy complexity in which is commonly referred to as “depth”. According to a type of construction, the forms of the deep learning may include a multi-layer perceptron, a convolutional neural network, a cyclic neural network, a deep confidence network, and other hybrid constructions. The deep learning uses data to update parameters in the construction to achieve a training goal, and the process is generally referred to as “learning”. The deep learning provides a method for a computer to learn pattern features automatically, and incorporates the feature learning into a process of building a model, thereby reducing incompleteness caused by artificial design features.

There are five types of intracerebral hemorrhage according to different bleeding sites: Epidural hematoma, Intraparenchymal hematoma, Intraventricular hematoma, Subarachnoid hematoma, and Subdural hematoma. However, since there are various types of cerebral hemorrhage and due to an impact of factors such as a manufacturer source of head medical image data and imaging quality of the head medical image, heterogeneity of head medical image data may result in a poor segmentation effect of a cerebral hematoma in a head medical image.

As for segmentation of the cerebral hematoma, a conventional machine learning method may be used, but it is limited to an artificial design of an algorithm, and it is difficult to ensure robustness on the head medical images of different manufacturer sources and different image quality; and of course, a deep learning method based on a deep neural network may alternatively be used, but the deep learning method is data-driven, and the heterogeneity of data and the inconsistency of data labeling during training may also lead to a poor segmentation effect of the cerebral hematoma in the head medical image.

As for the above-described technical problems, basic ideas of the present application are to provide a method for image segmentation. A secondary segmentation of a cerebral hematoma is performed on a pre-processed head medical image mainly on the basis of a preliminary segmentation result of the cerebral hematoma in a head medical image, to obtain a secondary segmentation result of the cerebral hematoma in the pre-processed head medical image, and a final segmentation result of the cerebral hematoma in the head medical image is acquired based on the secondary segmentation result, so that a segmentation effect of the cerebral hematoma in the head medical image can be improved in a case that the head medical image has data heterogeneity.

Following introduction of the basic principles of the present application, various non-limiting embodiments of the present application will be described in detail below with reference to the accompanying drawings.

Exemplary System

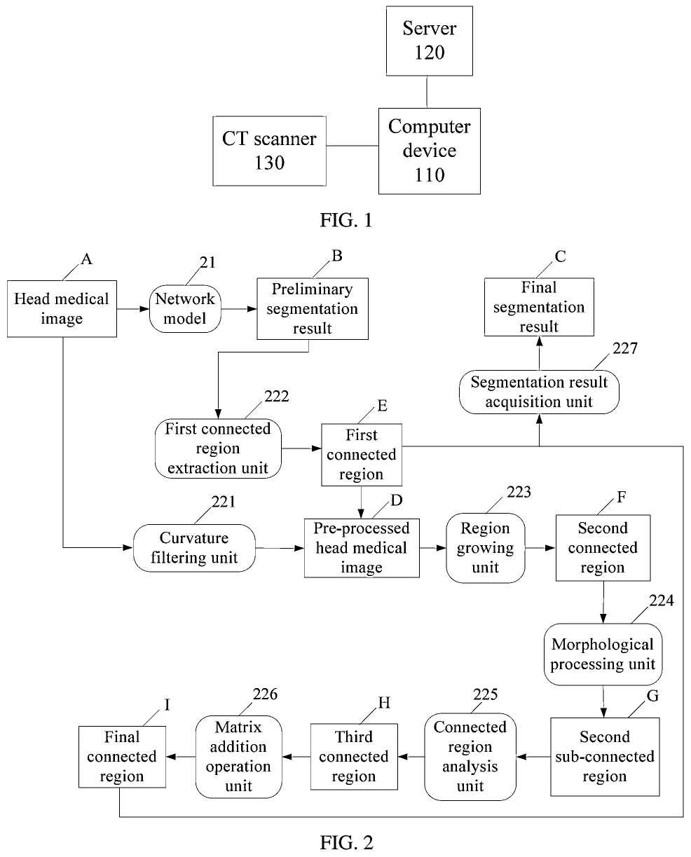

FIG. 1 is a schematic diagram of an implementation environment according to an embodiment of the present application. The implementation environment includes a CT scanner 130, a server 120, and a computer device 110. The computer device 110 may acquire a head medical image from the CT scanner 130. The computer device 110 may also be connected to the server 120 via a communication network. Optionally, the communication network is a wired network or a wireless network.

The CT scanner 130 is configured to perform X-ray scanning on human tissues to obtain a CT image of the human tissues. In one embodiment, a head may be scanned by the CT scanner 130 to obtain a head X-ray image, i.e., the head medical image in the present application.

The computer device 110 may be a general-purpose computer, a computer device composed of application-specific integrated circuits, or the like, and the embodiments of the present application are not limited thereto. For example, the computer device 110 may be a mobile terminal device such as a tablet computer, or may be a Personal Computer (PC), such as a laptop portable computer, a desktop computer, or the like. It may be appreciated by those skilled in the art that the number of the computer devices 110 described above may be one or more and that the types thereof may be the same or different. For example, there may be one computer device 110, or dozens or hundreds of computer devices 110 or more. The number of computer devices 110 and the type of devices are not limited in the embodiments of the present application. A network model may be deployed in the computer device 110 for performing a preliminary segmentation of the cerebral hematoma on the head medical image. The computer device 110 may perform the preliminary segmentation of the cerebral hematoma on the head medical image by using the network model deployed thereon, the head medical image is obtained from the CT scanner 130, thereby obtaining a preliminary segmentation result of the cerebral hematoma in the head medical image. Then, the computer device 110 performs a secondary segmentation of the cerebral hematoma on the pre-processed head medical image based on the preliminary segmentation result, thereby obtaining a secondary segmentation result of the pre-processed head medical image. Finally, the computer device 110 obtains a final segmentation result of the cerebral hematoma in the head medical image based on the secondary segmentation result. Thus, the segmentation effect of the cerebral hematoma in the head medical image can be improved regardless of whether the head medical image has data heterogeneity.

The server 120 is one server, or consists of several servers, or is a virtualization platform, or is a cloud computing service center. In some optional embodiments, the server 120 receives training images collected by the computer device 110, and trains a neural network through the training images, to obtain a network model for segmenting a cerebral hematoma. The computer device 110 may send the head medical image acquired from the CT scanner 130 to the server 120, and the server 120 performs a preliminary segmentation of the cerebral hematoma on the head medical image by using the network model trained thereon, to obtain a preliminary segmentation result of the cerebral hematoma in the head medical image, and then the server 120 performs a secondary segmentation of the cerebral hematoma on the pre-processed head medical image based on the preliminary segmentation result, to obtain a secondary segmentation result of the pre-processed head medical image, and then the server 120 acquires a final segmentation result of the cerebral hematoma in the head medical image based on the secondary segmentation result, and finally the server 120 sends the final segmentation result to the computer device 110 for a physician to view. Thus, the segmentation effect of the cerebral hematoma in the head medical image can be improved regardless of whether the head medical image has data heterogeneity.

FIG. 2 is a block diagram of a system for image segmentation according to an embodiment of the present application. As shown in FIG. 2, the system includes:

a network model 21, configured to obtain a preliminary segmentation result B of a cerebral hematoma in a head medical image based on a head medical image A;

a curvature filtering unit 221, configured to preprocess the head medical image A to obtain a pre-processed head medical image D;

a first connected region extraction unit 222, configured to: perform binarization processing on the preliminary segmentation result B to obtain a binary image corresponding to the preliminary segmentation result B, and perform connected region extraction of the cerebral hematoma on the binary image to obtain at least one first connected region E of the head medical image;

a region growing unit 223, configured to: acquire a seed point, corresponding to a center point of each of the at least one first connected region E, of the pre-processed head medical image D, and obtain at least one second connected region F of the pre-processed head medical image D by using a region growing algorithm and based on a preset boundary threshold and the seed point;

a morphological processing unit 224, configured to perform morphological processing on each of the at least one second connected region F, to obtain a plurality of second sub-connected regions G corresponding to the second connected region;

a connected region analysis unit 225, configured to obtain at least one third connected region H of the pre-processed head medical image D by using a preset rule and based on the plurality of second sub-connected regions G;

a matrix addition operation unit 226, configured to perform a matrix addition operation on the at least two third connected regions H to obtain a matrix addition operation value corresponding to each pixel of the pre-processed head medical image D, and perform majority voting processing on the matrix addition operation value corresponding to each pixel of the pre-processed head medical image D based on a matrix addition operation threshold, to obtain a final connected region I of the cerebral hematoma in the pre-processed head medical image D; and

a segmentation result acquiring unit 227, configured to perform a matrix addition operation on the final connected region I and the at least one first connected region E to obtain a final segmentation result C.

Referring to a data flow direction indicated by a solid line with arrows in FIG. 2, the final segmentation result C of the cerebral hematoma in the head medical image in the present embodiment is obtained in this manner.

The head medical image A may refer to one layer of medical image in an original head medical image. Each layer of medical image in the original medical image is subjected to the above processing to obtain a final segmentation result C corresponding to each layer of medical image, and the final segmentation result C corresponding to each layer of medical image is sequentially combined to obtain a three-dimensional cerebral hematoma segmentation mask.

Exemplary Method

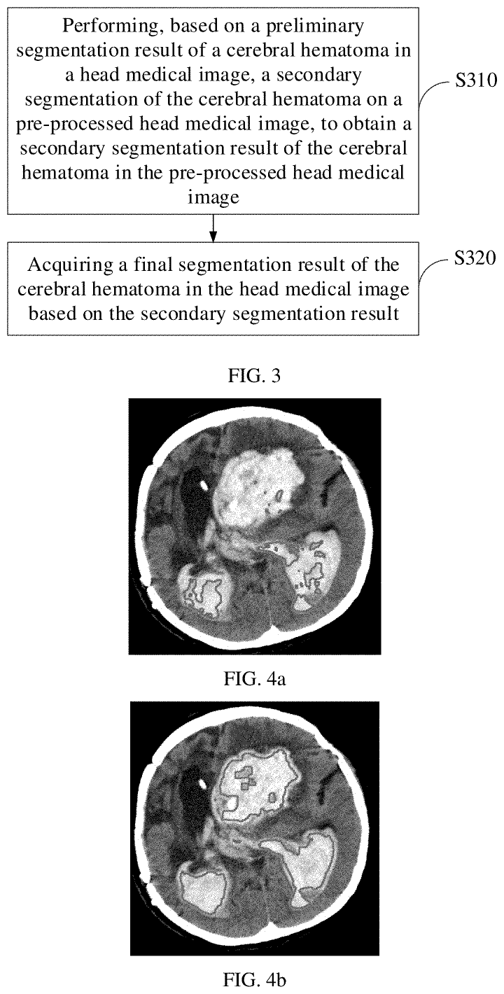

FIG. 3 is a schematic flowchart of a method for image segmentation according to an embodiment of the present application. The method described in FIG. 3 is performed by a computing device (e.g., a server), but embodiments of the present application are not limited thereto. The server may be a server, or may be composed of several servers, or may be a virtualization platform, or may be a cloud computing service center, which is not limited in the embodiments of the present application. As shown in FIG. 3, the method includes the following contents.

S310: performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image.

In one embodiment, the head medical image may refer to an original head medical image, which may be an image directly obtained by techniques such as Computed Tomography (CT), Computed Radiography (CR), Digital Radiography (DR), nuclear magnetic resonance, and ultrasound.

In one embodiment, the head medical image may be a three-dimensional head plain scan computed tomography imaging, or may be one layer of two-dimensional medical image in the three-dimensional head plain scan computed tomography imaging, which is not specifically limited in the present embodiment.

In one embodiment, the pre-processed head medical image may refer to a medical image obtained after the head medical image is preprocessed. However, the embodiments of the present application do not specifically limit the specific implementation of the preprocessing, which may refer to normalization, denoising processing, image enhancement processing, or the like.

For example, the preprocessing may be performed as following: performing curvature filtering on the head medical image to obtain the pre-processed head medical image. By the curvature filtering, edge information of the head medical image may be preserved and the head medical image may be denoised.

By pre-processing the head medical image, the secondary segmentation of the cerebral hematoma may be performed on the pre-processed head medical image, thereby eliminating an impact of factors such as data heterogeneity between the head medical images and inconsistency of data labeling during training on the segmentation effect of the cerebral hematoma.

In one embodiment, the head medical image may first be subjected to a preliminary segmentation of the cerebral hematoma to obtain a preliminary segmentation result, and the pre-processed head medical image may be subjected to the secondary segmentation of the cerebral hematoma based on the preliminary segmentation result to obtain the secondary segmentation result of the cerebral hematoma in the pre-processed head medical image.

It may be understood that the preliminary segmentation result is obtained based on the head medical image, and the secondary segmentation result is obtained based on the pre-processed head medical image. The preliminary segmentation result may be understood as a coarse segmentation result of the cerebral hematoma in the head medical image, and the secondary segmentation result may be understood as a fine segmentation result of the cerebral hematoma in the pre-processed head medical image obtained after optimization of the coarse segmentation result, that is, segmentation accuracy of the secondary segmentation result is higher than that of the preliminary segmentation result.

However, the embodiments of the present application do not specifically limit an implementation manner of the preliminary segmentation, as long as the preliminary segmentation of the cerebral hematoma may be performed on the head medical image. The embodiments of the present application do not specifically limit an implementation manner of the secondary segmentation, as long as the secondary segmentation of the cerebral hematoma may be performed on the pre-processed head medical image.

In one embodiment, the preliminary segmentation result may be obtained in the following way: obtaining the preliminary segmentation result by using a network model and based on the head medical image.

For example, the head medical image is input into the network model to perform the preliminary segmentation on the cerebral hematoma of the head medical image to obtain the preliminary segmentation result.

A specific type of the network model is not limited in the embodiments of the present application. The network model may be a shallow model obtained by machine learning, such as a Support Vector Machine (SVM) classifier or a linear regression classifier. The network model obtained by the machine learning may realize fast image segmentation, so as to improve the segmentation efficiency of the model. The network model may also refer to a deep-layer model obtained by deep learning. The network model may be composed of any type of neural networks, and the networks may be backbone networks such as ResNet, ResNeXt or DenseNet. The network model obtained by the deep learning may improve the segmentation accuracy of the model. Optionally, the network model may be a Convolutional Neural Network (CNN), a Deep Neural Network (DNN), a Recurrent Neural Network (RNN), or the like. The network model may include neural network layers such as an input layer, a convolution layer, a pooling layer, and a connection layer, which are not specifically limited in the embodiments of the present application. In addition, the number of each neural network layer is not limited in the embodiments of the present application.

S320: acquiring a final segmentation result of the cerebral hematoma in the head medical image based on the secondary segmentation result.

It should be noted that, how to obtain the final segmentation result of the cerebral hematoma in the head medical image based on the secondary segmentation result is not limited in the embodiments of the present application.

For example, the secondary segmentation result may be directly determined as the final segmentation result of the cerebral hematoma in the head medical image. The final segmentation result is a fine segmentation result of the cerebral hematoma in the head medical image, that is, the segmentation accuracy of the final segmentation result is higher than that of the preliminary segmentation result.

By directly determining the secondary segmentation result as the final segmentation result, it is possible to improve the segmentation effect of the cerebral hematoma while improving the segmentation efficiency of the cerebral hematoma.

For example, the secondary segmentation result may be optimized to obtain the final segmentation result of the cerebral hematoma in the head medical image, that is, the secondary segmentation result is only an intermediate result, and then the final segmentation result of the cerebral hematoma in the head medical image is obtained based on the intermediate result and another segmentation result. The final segmentation result is a fine segmentation result of the cerebral hematoma in the head medical image obtained after the secondary segmentation result is optimized, that is, the segmentation accuracy of the final segmentation result is higher than that of the secondary segmentation result, and the segmentation accuracy of the secondary segmentation result is higher than that of the preliminary segmentation result.

By optimizing the secondary segmentation result to obtain the final segmentation result, the segmentation effect of the cerebral hematoma may be maximally improved.

FIG. 4a shows a preliminary segmentation result of a cerebral hematoma in a head medical image. Obviously, the segmentation effect of the cerebral hematoma is not good enough. An obtained cerebral hematoma is divided into a plurality of small regions, and some cerebral hematomas are not segmented. FIG. 4b shows a final segmentation result of a cerebral hematoma in a head medical image. Obviously, the segmentation effect of the cerebral hematoma is good, and substantially all cerebral hematomas are segmented.

It can be seen that, in the embodiments of the present application, the segmentation effect of the cerebral hematoma in the head medical image may be improved by performing two-step segmentation, i.e., the preliminary segmentation of the head medical image and the secondary segmentation of the pre-processed head medical image, even if the above limitation factors (e.g., the data heterogeneity, and the inconsistency of the data labeling during training) may affect the segmentation effect.

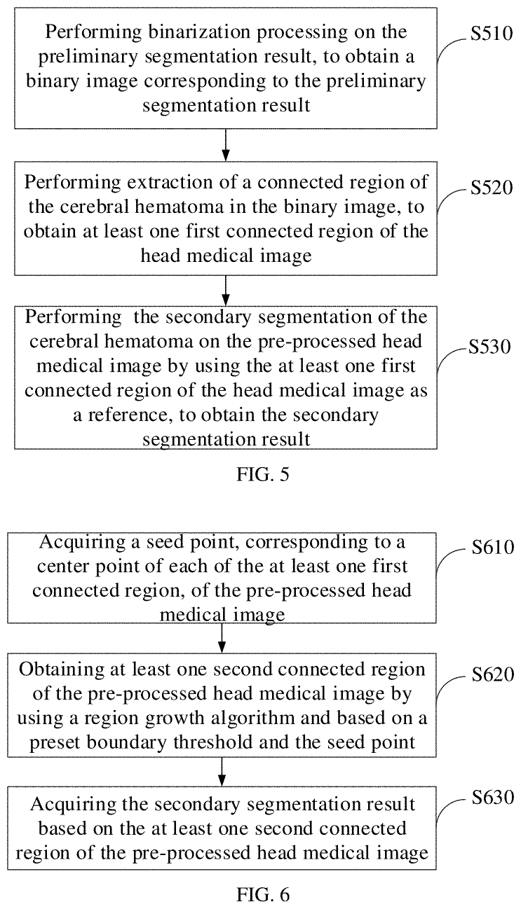

In another embodiment of the present application, the method shown in FIG. 5 is an example of the step S310 in the method shown in FIG. 3, and the method shown in FIG. 5 includes the following content.

S510: performing binarization processing on the preliminary segmentation result, to obtain a binary image corresponding to the preliminary segmentation result.

It should be understood that the preliminary segmentation result may be a cerebral hematoma segmentation mask of the head medical image, i.e., a probability of one region in the head medical image being a cerebral hematoma is 80% and a probability of the other region in the head medical image being a cerebral hematoma is 50%.

In one embodiment, by performing the binarization processing on the preliminary segmentation result, the binary image corresponding to the preliminary segmentation result may be obtained, that is, each pixel on the binary image may be represented by 0 or 1, where 1 denotes a pixel of a cerebral hematoma region, and 0 denotes a pixel of a background region.

S520: performing extraction of a connected region of the cerebral hematoma in the binary image, to obtain at least one first connected region of the head medical image.

In one embodiment, the at least one first connected region of the head medical image may be obtained by performing the extraction of the connected region of the cerebral hematoma in the binary image, one first connected region corresponding to a cerebral hematoma region in the head medical image.

An extraction algorithm of the connected region may be divided into two types: one is a local neighborhood algorithm, that is, each connected component is checked one by one from local to global, a “starting point” is determined, and a mark is extensively filled in a surrounding neighborhood of the starting point; and the other is to determine different connected components from whole to part, and then a mark is filled in each connected component by a region filling method. The final purposes of these two algorithms are that a pixel set with mutually adjacent target “1” and a pixel set with mutually adjacent target “0” are extracted from a dot matrix binary image composed of white pixels and black pixels, the pixel set with mutually adjacent target “1” is marked as a cerebral hematoma region, and the pixel set with mutually adjacent target “0” is marked as a background region.

S530: performing the secondary segmentation of the cerebral hematoma on the pre-processed head medical image by using the at least one first connected region of the head medical image as a reference, to obtain the secondary segmentation result.

It should be noted that, how to perform the secondary segmentation of the cerebral hematoma on the pre-processed head medical image by using the at least one first connected region of the head medical image as a reference to obtain the secondary segmentation result is not limited in the embodiments of the present application.

For example, the at least one first connected region in the head medical image is used as a reference, and the secondary segmentation of the cerebral hematoma may be performed on the pre-processed head medical image on the basis of the reference, thereby obtaining the secondary segmenting result of the cerebral hematoma in the pre-processed head medical image.

In another embodiment of the present application, the method shown in FIG. 6 is an example of the step S530 in the method shown in FIG. 5, and the method shown in FIG. 6 includes the following content.

S610: acquiring a seed point, corresponding to a center point of each of the at least one first connected region, of the pre-processed head medical image.

After the at least one first connected region of the head medical image is obtained, a center point of each of the at least one first connected region is calculated using a k-means clustering algorithm. Since a size of the head medical image is the same as that of the pre-processed head medical image, positions of all pixels on the head medical image are in a one-to-one correspondence with positions of all pixels on the pre-processed head medical image. That is, after the center point of the first connected region in the head medical image is determined, it is equivalent to that, in the pre-processed head medical image, the seed point corresponding to the center point of the first connected region is determined.

S620: obtaining at least one second connected region of the pre-processed head medical image by using a region growth algorithm and based on a preset boundary threshold and the seed point.

In the pre-processed head medical image, a preset boundary threshold is used as a boundary, the seed point is used as a start point of region growth, and the preset boundary threshold is used as a track of the region growth, so that the seed point extends further to an extension region, and then to a boundary of the preset boundary threshold by using the region growth algorithm (RegionGrowth), thereby obtaining the at least one second connected region in the pre-processed head medical image.

For example, the preset boundary threshold is used as a radius of a circle, and the seed point extends further to the extension region, and then to the boundary of the preset boundary threshold, to obtain a second connected region in a shape of a circle, or the preset boundary threshold is used as a side length of a square, and the seed point extends further to the extension region, and then to the boundary of the preset boundary threshold, to obtain a second connected region in a shape of a square, which is not specifically limited in the embodiments of the present application.

A quantity of the first connected regions is equal to a quantity of the second connected region, and one first connected region corresponds to one second connected region. However, a pixel size of the first connected region and a pixel size of the second connected region are not specifically limited in the embodiments of the present application.

It should be noted that, a specific value of the preset boundary threshold is not specifically limited in the embodiments of the present application, and a person skilled in the art may set the value of the preset boundary threshold according to actual requirements.

S630: acquiring the secondary segmentation result based on the at least one second connected region of the pre-processed head medical image.

It should be noted that, how to obtain the secondary segmentation result based on the at least one second connected region of the pre-processed head medical image is not limited in the embodiments of the present application.

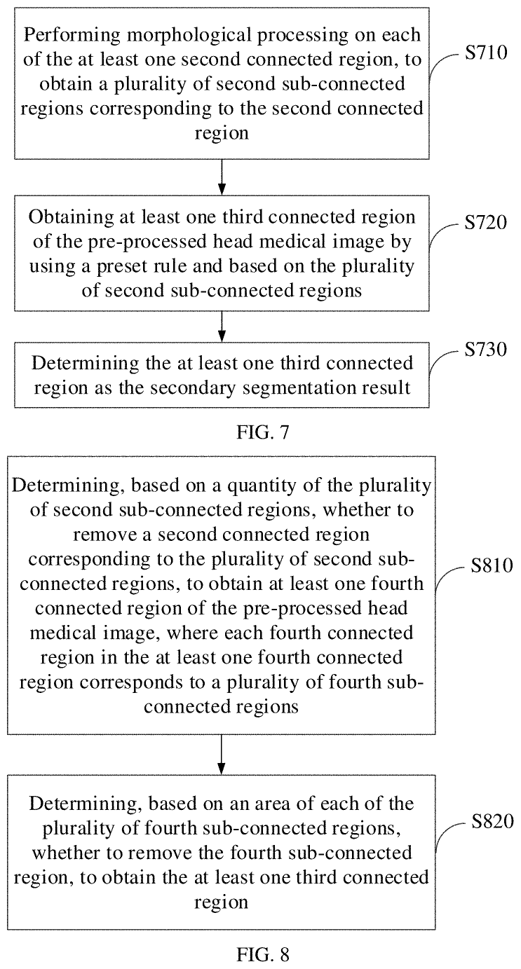

In another embodiment of the present application, the method shown in FIG. 7 is an example of the step S630 in the method shown in FIG. 6, and the method shown in FIG. 7 includes the following content.

S710: performing morphological processing on each of the at least one second connected region, to obtain a plurality of second sub-connected regions corresponding to the second connected region.

The morphological processing is performed on each of the at least one second connected region. For example, a corrosion operation is performed on the second connected region, and then a dilation expansion operation is performed on the second connected region, or a dilation operation is performed on the second connected region, and then a corrosion operation is performed on the second connected region, to divide the second connected region into a plurality of second sub-connected regions. That is, the morphologically processed second connected region includes a plurality of second sub-connected regions.

It should be noted that, which morphological process may be used to obtain the plurality of second sub-connected regions is not limited in the embodiments of the present application. Expansion and corrosion are the basis of morphological operations, and different combinations thereof constitute region filling, an open operation and a closed operation. The dilation operation is an operation to make a target in the image coarser or growing, which may fill gaps of edges and solve the problem of broken lines of the edges.

S720: obtaining at least one third connected region of the pre-processed head medical image by using a preset rule and based on the plurality of second sub-connected regions.

After the plurality of second sub-connected region are obtained, a preset rule may be used to determine whether the plurality of second sub-connected region correspond to a cerebral hematoma region, that is, to determine which second sub-connected regions are background regions or noise regions. The second sub-connected region that does not correspond to the cerebral hematoma region is removed, thereby obtaining the at least one third connected region of the pre-processed head medical image.

It will be appreciated that the remaining second sub-connected regions which are obtained after the second sub-connected region that does not correspond to the cerebral hematoma region is removed is the third connected region of the present application.

However, it should be noted that, the preset rule is not specifically limited in the embodiments of the present application, as long as the second sub-connected region that does not correspond to the cerebral hematoma region can be removed.

S730: determining the at least one third connected region as the secondary segmentation result.

In one embodiment, the at least one third connected region refers to the secondary segmentation result of the pre-processed head medical image.

In another embodiment of the present application, the acquiring a final segmentation result of the cerebral hematoma in the head medical image based on the secondary segmentation result includes: acquiring the final segmentation result based on the at least one third connected region.

It should be noted that, how to obtain the final segmentation result based on the at least one third connected region is not limited in the embodiments of the present application. For example, the third connected region may be directly determined as the final segmentation result, or the third connected region and another connected region may be combined to obtain the final segmentation result.

In another embodiment of the present application, the method shown in FIG. 8 is an example of the step S720 in the method shown in FIG. 7, and the method shown in FIG. 8 includes the following content.

S810: determining, based on a quantity of the plurality of second sub-connected regions, whether to remove a second connected region corresponding to the plurality of second sub-connected regions, to obtain at least one fourth connected region of the pre-processed head medical image, each of the at least one fourth connected region corresponding to a plurality of fourth sub-connected regions.

First, a quantity of the second sub-connected regions obtained after the morphological processing cannot be too large, that is, the quantity of the second sub-connected regions is too large, indicating that the second connected region includes the second sub-connected regions corresponding to the background region or the noise region. Therefore, it is possible to determine, based on the quantity of the plurality of second sub-connected regions, whether to remove the second connected region corresponding to the plurality of second sub-connected regions, to obtain the at least one fourth connected region of the pre-processed head medical image. The remaining second connected regions which are obtained after the second connected region corresponding to the plurality of second sub-connected regions is removed is the fourth connected region of the present application, and the fourth connected region consists of a plurality of fourth sub-connected regions.

S820: determining, based on an area of each of the plurality of fourth sub-connected regions, whether to remove the fourth sub-connected region, to obtain the at least one third connected region.

Secondly, the area of the fourth sub-connected region cannot be too small, that is, the area of the fourth sub-connected region is too small, indicating that the fourth sub-connected region may be the noise region or the background region. Therefore, it is possible to determine whether to remove the fourth sub-connected region based on the area of each of the plurality of fourth sub-connected regions to obtain the at least one third connected region. The fourth connected region corresponding to the remaining fourth sub-connected regions which are obtained after the fourth sub-connected region is removed is the third connected region of the present application.

Thus, in the above manners, it is possible to remove the connected region not corresponding to the cerebral hematoma region, i.e., the second connected region corresponding to the background region or the noise region, and the fourth sub-connected region corresponding to the noise region, thereby obtaining the third connected region.

In another embodiment of the present application, the determining, based on a quantity of the plurality of second sub-connected regions, whether to remove a second connected region corresponding to the plurality of second sub-connected regions, to obtain at least one fourth connected region of the pre-processed head medical image includes: comparing the quantity of the plurality of second sub-connected regions with a preset quantity threshold; and removing the second connected region having a quantity of the plurality of second sub-connected regions greater than the preset quantity threshold, to obtain the at least one fourth connected region.

By comparing the quantity of the plurality of second sub-connected regions with the preset quantity threshold, it may be determined whether the quantity of the plurality of second sub-connected regions is large enough to include the background region or the noise region. When the quantity of the plurality of second sub-connected regions is greater than the preset quantity threshold, the second connected region corresponding to the plurality of second sub-connected regions is removed to obtain the at least one fourth connected region.

However, a specific value of the preset quantity threshold is not limited in the embodiments of the present application. For example, the preset quantity threshold may be set to three or four, etc.

In another embodiment of the present application, the determining, based on an area of each fourth sub-connected region of the plurality of fourth sub-connected regions, whether to remove the fourth sub-connected region, to obtain the at least one third connected region includes: comparing an area of each of the plurality of fourth sub-connected regions with a cerebral hematoma area threshold; and removing the fourth sub-connected region, having an area less than the cerebral hematoma area threshold, of the plurality of fourth sub-connected regions, to obtain the at least one third connected region.

By comparing the area of each of the plurality of fourth sub-connected region with the cerebral hematoma area threshold, it may be determined whether the area of the fourth sub-connected region is small enough to be equal to the area of the noise region. When the area of the fourth sub-connected region is less than the cerebral hematoma area threshold, the fourth sub-connected region is removed to obtain the at least one third connected region. However, the embodiments of the present application are not limited thereto, it may also be determined whether the area of the fourth sub-connected region is large enough to be equal to the area of the background region, and when the area of the fourth sub-connected region is larger than the cerebral hematoma area threshold, the fourth sub-connected region is removed to obtain the at least one third connected region.

However, a specific value of the cerebral hematoma area threshold is not limited in the embodiments of the present application, and a person skilled in the art may set the specific value of the cerebral hematoma area threshold according to actual requirements.

It should be understood that removing a connected region may be understood as amending a pixel with “1” and corresponding to the connected region to a pixel with “0”.

The at least one third connected region obtained by the above-mentioned preset rules may more accurately represents the actual cerebral hematoma region, that is, all the cerebral hematoma regions in the head medical image may be represented by the at least one third connected region.

In another embodiment of the present application, the method for obtaining the at least one third connected region is not limited to using the preset rules mentioned above. The preset rule may be to determine only the area of the second sub-connected region or to determine only the quantity of the plurality of second sub-connected regions, to obtain the at least one third connected region.

By the preset rules described above, it is possible to obtain the at least one third connected region more quickly, so that the at least one third connected region represents the actual cerebral hematoma region.

In another embodiment of the present application, in a case that the at least one third connected region includes at least two third connected regions, the acquiring the final segmentation result based on the at least one third connected region includes: performing a matrix addition operation on the at least two third connected regions, to obtain a matrix addition operation value corresponding to each pixel of the pre-processed head medical image, the matrix addition operation value being obtained by adding at least two binary values; performing, based on a matrix addition operation threshold, majority vote binarization processing on the matrix addition operation value corresponding to each pixel of the pre-processed head medical image, to obtain a final connected region of the cerebral hematoma in the pre-processed head medical image; and performing a matrix addition operation on the final connected region and the at least one first connected region, to obtain the final segmentation result.

All the connected regions in the present application may be understood as the connected region mask, which is a matrix composed of pixels with “0” or “1”. All the pixels with “1” constitute the cerebral hematoma region, and all the pixels with “0” constitute the background region.

In one embodiment, the matrix addition operation is performed on the at least two third connected region masks, i.e., the addition of 0 and 1 is implemented, to obtain the matrix addition value corresponding to each pixel of the pre-processed head medical image.

It should be understood that the matrix addition value refers to an operation value obtained by adding at least two “0” or “1” (i.e., binarized values). For example, as for a pixel, the pixel of five third connected region masks corresponds to 1, 0, 1, 0, and 1, respectively. The matrix addition operation is performed on the five third connected region masks, and the obtained matrix addition operation value corresponding to the pixel is 1+0+1+0+1=3.

In one embodiment, after the matrix addition operation value corresponding to each pixel is obtained, the matrix addition operation value is compared with the matrix addition operation threshold, to implement the majority vote binarization processing on the matrix addition operation value corresponding to each pixel, that is, a pixel having a matrix addition operation value greater than or equal to the matrix addition operation threshold is determined as a pixel with a binary value of “1”, indicating that the pixel is located in the cerebral hematoma region; and a pixel having a matrix addition value less than the matrix addition operation threshold is determined as a pixel with a binary value of “0”, indicating that the pixel is located in the background region, thereby obtaining the final connected region of the cerebral hematoma in the pre-processed head medical image.

However, it should be noted that, a specific value of the matrix addition operation threshold is not specifically limited in the embodiments of the present application, and a person skilled in the art may obtain different matrix addition operation thresholds according to actual requirements. For example, if the matrix addition operation threshold is set to 2, the matrix addition operation value corresponding to a pixel is 3, the pixel is determined as the pixel with the binary value of “1”, and the matrix addition operation value corresponding to the pixel is 1, the pixel is determined as the pixel with the binary value of “0”.

In one embodiment, the matrix addition operation is performed on the final connected region mask of the cerebral hematoma in the pre-processed head medical image and the at least one first connected region mask of the head medical image to obtain the matrix addition operation value corresponding to each pixel of the head medical image. A binarization operation is performed on the matrix addition operation value, that is, a pixel having a matrix addition operation value greater than or equal to 1 is determined as a pixel with a binary value of “1”, and a pixel having a matrix addition operation value equal to 0 is determined as a pixel with a binary value of “0”, thereby obtaining the binarization final segmentation result of the cerebral hematoma in the pre-processed head medical image.

The binarization final segmentation result may be understood as a cerebral hematoma segmentation mask, that is, all pixels with “1” in the cerebral hematoma segmentation mask constitute the cerebral hematoma region, and all pixels with “0” constitute the background region.

In another embodiment of the present application, in a case that the at least one third connected region includes one third connected region, the acquiring the final segmentation result based on the at least one third connected region includes: performing a matrix addition operation on the one third connected region and the at least one first connected region, to obtain the final segmentation result.

In the case that the quantity of the at least one third connected region is one, the matrix addition operation may be directly performed on the one third connected region of the pre-processed head medical image and the at least one first connected region of the head medical image, to obtain a matrix addition operation value corresponding to each pixel of the pre-processed head medical image, and a binarization operation is performed on the matrix addition operation value, that is, a pixel having a matrix addition operation value greater than or equal to “1” is determined as a pixel with a binary value of “1”, and a pixel having a matrix addition operation value equal to “0” is still a pixel with a binary value of “0”, thereby obtaining the final segmentation result of the cerebral hematoma in the head medical image.

By performing the matrix addition operation on the connected region of the pre-processed head medical image and the at least one first connected region of the head medical image, a more accurate final segmentation result of the cerebral hematoma in the head medical image can be obtained even if there are the above limitation factors that may affect the segmentation effect, for example, the data heterogeneity and the inconsistency of data labeling during training, etc.

Exemplary Apparatus

The apparatus embodiments of the present application may be used to implement the method embodiments of the present application. For details not disclosed in the apparatus embodiments of the present application, please refer to the method embodiments of the present application.

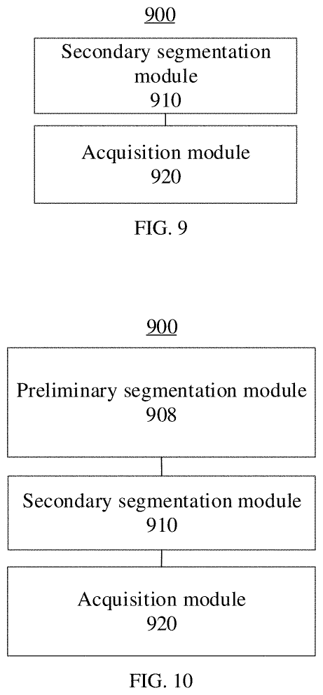

FIG. 9 is a block diagram of an apparatus for image segmentation according to an embodiment of the present application. As shown in FIG. 9, the apparatus 900 includes:

a secondary segmentation module 910, configured to perform, based on a preliminary segmentation result of a cerebral hematoma in a head medical image, a secondary, a secondary segmentation of the cerebral hematoma on a pre-processed head medical image, to obtain a secondary segmentation result of the cerebral hematoma in the pre-processed head medical image; and

an acquisition module 920, configured to acquire a final segmentation result of the cerebral hematoma in the head medical image based on the secondary segmentation result.

In one embodiment, the secondary segmentation module 910 is further configured to: perform binarization processing on the preliminary segmentation result, to obtain a binary image corresponding to the preliminary segmentation result; perform extraction of a connected region of the cerebral hematoma in the binary image, to obtain at least one first connected region of the head medical image; and perform the secondary segmentation of the cerebral hematoma on the pre-processed head medical image by using the at least one first connected region of the head medical image as a reference, to obtain the secondary segmentation result.

In one embodiment, when the secondary segmentation of the cerebral hematoma is performed on the pre-processed head medical image by using the at least one first connected region of the head medical image as the reference, the secondary segmentation module 910 is further configured to: acquire a seed point, corresponding to a center point of each of the at least one first connected region, of the pre-processed head medical image; obtain at least one second connected region of the pre-processed head medical image by using a region growth algorithm and based on a preset boundary threshold and the seed point; and acquire the secondary segmentation result based on the at least one second connected region of the pre-processed head medical image.

In one embodiment, when the secondary segmentation result is acquired based on the at least one second connected region of the pre-processed head medical image, the secondary segmentation module 910 is further configured to: perform morphological processing on each of the at least one second connected region, to obtain a plurality of second sub-connected regions corresponding to the second connected region; obtain at least one third connected region of the pre-processed head medical image by using a preset rule and based on the plurality of second sub-connected regions; and determine the at least one third connected region as the secondary segmentation result.

In one embodiment, the acquisition module 920 is further configured to acquire the final segmentation result based on the at least one third connected region.

In one embodiment, in a case that the at least one second connected region includes at least two second connected regions, when the at least one third connected region of the pre-processed head medical image is obtained by the preset rule and based on the plurality of second sub-connected regions, the secondary segmentation module 910 is further configured to: determine, based on a quantity of the plurality of second sub-connected regions, whether to remove a second connected region corresponding to the plurality of second sub-connected regions, to obtain at least one fourth connected region of the pre-processed head medical image, each of the at least one fourth connected region corresponding to a plurality of fourth sub-connected regions; and determine, based on an area of each of the plurality of fourth sub-connected regions, whether to remove the fourth sub-connected region, to obtain the at least one third connected region.

In one embodiment, when whether to remove the second connected region corresponding to the plurality of second sub-connected regions is determined based on the quantity of the plurality of second sub-connected regions, the secondary segmentation module 910 is further configured to: compare the quantity of the plurality of second sub-connected regions with a preset quantity threshold; and remove the second connected region having a quantity of the plurality of second sub-connected regions greater than the preset quantity threshold, to obtain the at least one fourth connected region.

In one embodiment, when whether to remove the fourth sub-connected region is determined based on the area of each of the plurality of fourth sub-connected regions, the secondary segmentation module 910 is further configured to: compare an area of each of the plurality of fourth sub-connected regions with a cerebral hematoma area threshold; and remove the fourth sub-connected region of the plurality of fourth sub-connected regions having an area less than the cerebral hematoma area threshold, to obtain the at least one third connected region.

In one embodiment, when the at least one third connected region of the pre-processed head medical image is obtained by the preset rule and based on the plurality of second sub-connected regions, the secondary segmentation module 910 is further configured to determine, based on an area of each of the plurality of second sub-connected regions, whether to remove the second sub-connected region, to obtain the at least one third connected region.

In one embodiment, in a case that the at least one second connected region includes at least two second connected regions, when the at least one third connected region of the pre-processed head medical image is obtained by the preset rule and based on the plurality of second sub-connected regions, the secondary segmentation module 910 is further configured to determine, based on a quantity of the plurality of second sub-connected regions, whether to remove a second connected region corresponding to the plurality of second sub-connected regions, to obtain the at least one third connected region.

In one embodiment, in a case that the at least one third connected region includes at least two third connected regions, when the final segmentation result is acquired based on the at least one third connected region, the acquisition module 920 is further configured to: perform a matrix addition operation on the at least two third connected regions, to obtain a matrix addition operation value corresponding to each pixel of the pre-processed head medical image, the matrix addition operation value being obtained by adding at least two binary values; perform, based on a matrix addition operation threshold, majority vote binarization processing on the matrix addition operation value corresponding to each pixel of the pre-processed head medical image, to obtain a final connected region of the cerebral hematoma in the pre-processed head medical image; and perform a matrix addition operation on the final connected region and the at least one first connected region, to obtain the final segmentation result.

In one embodiment, in a case that the at least one third connected region includes one third connected region, when the final segmentation result is acquired based on the at least one third connected region, the acquisition module 920 is further configured to perform a matrix addition operation on the one third connected region and the at least one first connected region, to obtain the final segmentation result.

In one embodiment, as shown in FIG. 10, the apparatus 900 further includes a preliminary segmentation module 908 configured to obtain the preliminary segmentation result by using a network model and based on the head medical image.

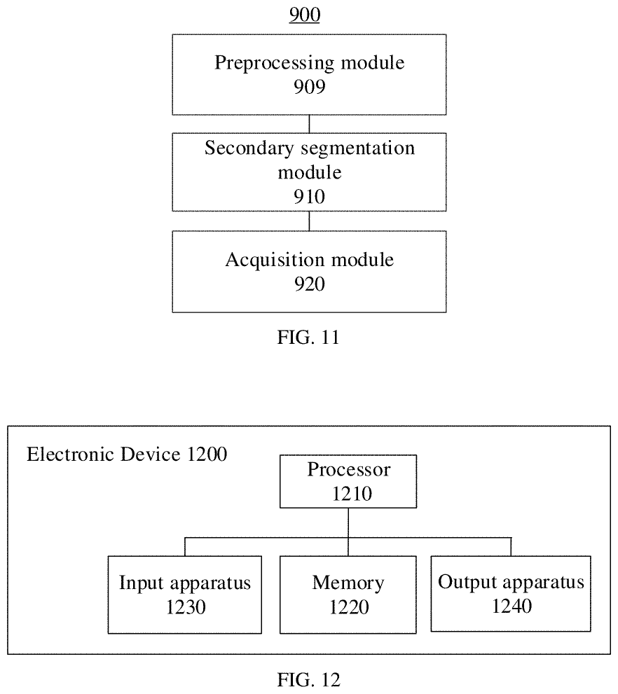

In one embodiment, as shown in FIG. 11, the apparatus 900 further includes a preprocessing module 909 configured to perform curvature filtering on the head medical image to obtain the pre-processed head medical image.

Exemplary Electronic Device

The following describes an electronic device according to an embodiment of the present application with reference to FIG. 12. FIG. 12 is a block diagram of an electronic device according to an embodiment of the present application.

As shown in FIG. 12, the electronic device 1200 includes one or more processors 1210 and a memory 1220.

The processor 1210 may be a Central Processing Unit (CPU) or any other form of processing unit with data processing capability and/or instruction execution capability, and may control other components in the electronic device 1200 to perform desired functions.

The memory 1220 may include one or more computer program products, which may include computer-readable storage media in various forms, such as a volatile memory and/or non-volatile memory. The volatile memory may include, for example, a Random Access Memory (RAM), and a cache. The non-volatile memory may include, for example, a Read-Only Memory (ROM), a hard disk, and a flash memory. One or more computer program instructions may be stored on the computer-readable storage medium, and the processor 1210 may execute the program instructions to implement the methods for image segmentation and/or other desired functions of the various embodiments of the present application described above. Various contents such as an input signal, a signal component, and a noise component may also be stored in the computer-readable storage medium.

In one example, the electronic device 1200 may further include an input apparatus 1230 and an output apparatus 1240 which are interconnected to each other by using a bus system and/or a connection mechanism (not shown) in other forms.

For example, the input apparatus 1230 may be a microphone or microphone array described above for capturing an input signal of a sound source. When the electronic device is a stand-alone device, the input apparatus 1230 may be a communication network connector.

In addition, the input apparatus 1230 may further include, for example, a keyboard, a mouse, and so on.

The output apparatus 1240 may output various information to the outside, including the identified sign category information and the like. The output apparatus 1240 may include, for example, a display, a speaker, a printer, a communication network, and a remote output device to which it is connected.

Of course, for simplicity, only some of the components of the electronic device 1200 related to the present application are shown in FIG. 12, and other components such as a bus, or an input/output interface are omitted. In addition, the electronic device 1200 may further include any other suitable components depending on the particular application situations.

Exemplary Computer Program Product and Computer-Readable Storage Medium

In addition to the above-described methods and apparatus, the embodiments of the present application may alternatively be a computer program product. The computer program product includes computer program instructions. When the computer program instructions are run by a processor, the processor implements the steps of the method for image segmentation according to various embodiments of the present application described in the above-described “Exemplary Method” section of the present specification.

The computer program product may be used to write a program code for performing the operations in the embodiments of the present application in any combination of one or more programming languages. The programming languages include object-oriented programming languages, such as Java, C++, and may also include conventional procedural programming languages, such as “C” language or similar programming languages. The program code may be executed entirely on a user's computing device, or executed partially on a user's device, or executed as a stand-alone software package, or executed partially on a user's computing device, or executed partially on a remote computing device, or executed entirely on a remote computing device or a server.

In addition, the embodiments of the present application may alternatively be a computer-readable storage medium, on which computer program instructions are stored. When the computer program instructions are executed by a processor, the processor implements the steps of the method for image segmentation according to various embodiments of the present application described in the above-described “Exemplary Method” section of the present specification.

The computer-readable storage medium may employ one or any combination of more readable media. The readable medium may be a readable signal medium or a readable storage medium. The readable storage medium may include, for example, but is not limited to, an electrical, magnetic, optical, electromagnetic, infrared, or semiconductor system, apparatus, or devices, or combinations of any of the foregoing. More specific examples (a non-exhaustive list) of the readable storage medium include an electrical connection having one or more wires, a portable disk, a hard disk, a Random Access Memory (RAM), a Read Only Memory (ROM), an Erasable Programmable Read Only Memory (EPROM), a flash memory, an optical fiber, a portable Compact Disk Read Only Memory (CD-ROM), an optical storage device, a magnetic storage device, or any suitable combination of the foregoing.

The above description has been presented for purposes of illustration and description. Moreover, this description is not intended to limit the embodiments of the present application to the forms disclosed herein. Although a plurality of exemplary aspects and embodiments have been discussed above, those skilled in the art will recognize some variations, modifications, changes, additions, and sub-combinations thereof.

What is claimed is:

1. A method for image segmentation, comprising:
performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image; and
acquiring a final segmentation result of the cerebral hematoma in the head medical image based on the secondary segmentation result.

2. The method according to claim 1, wherein the performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image comprises:
performing binarization processing on the preliminary segmentation result, to obtain a binary image corresponding to the preliminary segmentation result;
performing extraction of a connected region of the cerebral hematoma in the binary image, to obtain at least one first connected region of the head medical image; and
performing the secondary segmentation of the cerebral hematoma on the pre-processed head medical image by using the at least one first connected region of the head medical image as a reference, to obtain the secondary segmentation result.

3. The method according to claim 2, wherein the performing the secondary segmentation of the cerebral hematoma on the pre-processed head medical image by using the at least one first connected region of the head medical image as a reference, to obtain the secondary segmentation result comprises:
acquiring a seed point, corresponding to a center point of each of the at least one first connected region, of the pre-processed head medical image;
obtaining at least one second connected region of the pre-processed head medical image by using a region growth algorithm and based on a preset boundary threshold and the seed point; and
acquiring the secondary segmentation result based on the at least one second connected region of the pre-processed head medical image.

4. The method according to claim 3, wherein the acquiring the secondary segmentation result based on the at least one second connected region of the pre-processed head medical image comprises:
performing morphological processing on each of the at least one second connected region, to obtain a plurality of second sub-connected regions corresponding to the second connected region;
obtaining at least one third connected region of the pre-processed head medical image by using a preset rule and based on the plurality of second sub-connected regions; and
determining the at least one third connected region as the secondary segmentation result,
wherein the acquiring a final segmentation result of the cerebral hematoma in the head medical image based on the secondary segmentation result comprises:
acquiring the final segmentation result based on the at least one third connected region.

5. The method according to claim 4, wherein in a case that the at least one second connected region comprises at least two second connected regions, the obtaining at least one third connected region of the pre-processed head medical image by using a preset rule and based on the plurality of second sub-connected regions comprises:
determining, based on a quantity of the plurality of second sub-connected regions, whether to remove a second connected region corresponding to the plurality of second sub-connected regions, to obtain at least one fourth connected region of the pre-processed head medical image, each of the at least one fourth connected region corresponding to a plurality of fourth sub-connected regions; and
determining, based on an area of each of the plurality of fourth sub-connected regions, whether to remove the fourth sub-connected region, to obtain the at least one third connected region.

6. The method according to claim 5, wherein the determining, based on a quantity of the plurality of second sub-connected regions, whether to remove a second connected region corresponding to the plurality of second sub-connected regions, to obtain at least one fourth connected region of the pre-processed head medical image comprises:
comparing the quantity of the plurality of second sub-connected regions with a preset quantity threshold; and
removing the second connected region having a quantity of the plurality of second sub-connected regions greater than the preset quantity threshold, to obtain the at least one fourth connected region.

7. The method according to claim 5, wherein the determining, based on an area of each fourth sub-connected region of the plurality of fourth sub-connected regions, whether to remove the fourth sub-connected region, to obtain the at least one third connected region comprises:
comparing an area of each of the plurality of fourth sub-connected regions with a cerebral hematoma area threshold; and
removing the fourth sub-connected region, having an area less than the cerebral hematoma area threshold, of the plurality of fourth sub-connected regions, to obtain the at least one third connected region.

8. The method according to claim 4, wherein the obtaining at least one third connected region of the pre-processed head medical image by using a preset rule and based on the plurality of second sub-connected regions comprises:
determining, based on an area of each of the plurality of second sub-connected regions, whether to remove the second sub-connected region, to obtain the at least one third connected region.

9. The method according to claim 4, wherein in a case that the at least one second connected region comprises at least two second connected regions, the obtaining at least one third connected region of the pre-processed head medical image by using a preset rule and based on the plurality of second sub-connected regions comprises:
determining, based on a quantity of the plurality of second sub-connected regions, whether to remove a second connected region corresponding to the plurality of second sub-connected regions, to obtain the at least one third connected region.

10. The method according to claim 4, wherein in a case that the at least one third connected region comprises at least two third connected regions, the acquiring the final segmentation result based on the at least one third connected region comprises:
performing a matrix addition operation on the at least two third connected regions, to obtain a matrix addition operation value corresponding to each pixel of the pre-processed head medical image, the matrix addition operation value being obtained by adding at least two binary values;
performing, based on a matrix addition operation threshold, majority vote binarization processing on the matrix addition operation value corresponding to each pixel of the pre-processed head medical image, to obtain a final connected region of the cerebral hematoma in the pre-processed head medical image; and
performing a matrix addition operation on the final connected region and the at least one first connected region, to obtain the final segmentation result.

11. The method according to claim 4, wherein in a case that the at least one third connected region comprises one third connected region, the acquiring the final segmentation result based on the at least one third connected region comprises:
performing a matrix addition operation on the one third connected region and the at least one first connected region, to obtain the final segmentation result.

12. The method according to claim 1, further comprising:
obtaining the preliminary segmentation result by using a network model and based on the head medical image.

13. The method according to claim 1, further comprising:
performing curvature filtering on the head medical image to obtain the pre-processed head medical image.

14. An electronic device, comprising:
a processor; and
a memory for storing processor-executable instructions,
wherein the processor is configured to perform the following steps:
performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image; and
acquiring a final segmentation result of the cerebral hematoma in the head medical image based on the secondary segmentation result.

15. The electronic device according to claim 14, wherein the performing, based on a preliminary segmentation result of a cerebral hematoma in a head medical image, a secondary segmentation of the cerebral hematoma on a pre-processed head medical image, to obtain a secondary segmentation result of the cerebral hematoma in the pre-processed head medical image comprises:
performing binarization processing on the preliminary segmentation result, to obtain a binary image corresponding to the preliminary segmentation result;
performing extraction of a connected region of the cerebral hematoma in the binary image, to obtain at least one first connected region of the head medical image; and
performing the secondary segmentation of the cerebral hematoma on the pre-processed head medical image by using the at least one first connected region of the head medical image as a reference, to obtain the secondary segmentation result.

16. The electronic device according to claim 15, wherein the performing the secondary segmentation of the cerebral hematoma on the pre-processed head medical image by using the at least one first connected region of the head medical image as a reference, to obtain the secondary segmentation result comprises:
acquiring a seed point, corresponding to a center point of each of the at least one first connected region, of the pre-processed head medical image;
obtaining at least one second connected region of the pre-processed head medical image by using a region growth algorithm and based on a preset boundary threshold and the seed point; and
acquiring the secondary segmentation result based on the at least one second connected region of the pre-processed head medical image.

17. The electronic device according to claim 16, wherein the acquiring the secondary segmentation result based on the at least one second connected region of the pre-processed head medical image comprises:
performing morphological processing on each of the at least one second connected region, to obtain a plurality of second sub-connected regions corresponding to the second connected region;
obtaining at least one third connected region of the pre-processed head medical image by using a preset rule and based on the plurality of second sub-connected regions; and
determining the at least one third connected region as the secondary segmentation result, wherein the acquiring a final segmentation result of the cerebral hematoma in the head medical image based on the secondary segmentation result comprises:
acquiring the final segmentation result based on the at least one third connected region.

18. The electronic device according to claim 17, wherein in a case that the at least one second connected region comprises at least two second connected regions, the obtaining at least one third connected region of the pre-processed head medical image by using a preset rule and based on the plurality of second sub-connected regions comprises:
determining, based on a quantity of the plurality of second sub-connected regions, whether to remove a second connected region corresponding to the plurality of second sub-connected regions, to obtain at least one fourth connected region of the pre-processed head medical image, each of the at least one fourth connected region corresponding to a plurality of fourth sub-connected regions; and
determining, based on an area of each of the plurality of fourth sub-connected regions, whether to remove the fourth sub-connected region, to obtain the at least one third connected region.

19. The electronic device according to claim 17, wherein the obtaining at least one third connected region of the pre-processed head medical image by using a preset rule and based on the plurality of second sub-connected regions comprises:
determining, based on an area of each of the plurality of second sub-connected regions, whether to remove the second sub-connected region, to obtain the at least one third connected region.

20. The electronic device according to claim 17, wherein in a case that the at least one second connected region comprises at least two second connected regions, the obtaining at least one third connected region of the pre-processed head medical image by using a preset rule and based on the plurality of second sub-connected regions comprises:
determining, based on a quantity of the plurality of second sub-connected regions, whether to remove a second connected region corresponding to the plurality of second sub-connected regions, to obtain the at least one third connected region.
